(19) United States
(12) Patent Application Publication
(10) Pub. No.: US 2014/0143279 A1
(43) Pub. Date: May 22, 2014

(54) CONSUMER-SPECIFIC BUSINESS OBJECT EXTENSIBILITY VIA INHERITANCE

(71) Applicants: Marco Eidinger, Ludwigshafen (DE); Thomas Maag, Reilingen (DE); Michael Raich, Pfaffenhofen (AT)

(72) Inventors: Marco Eidinger, Ludwigshafen (DE); Thomas Maag, Reilingen (DE); Michael Raich, Pfaffenhofen (AT)

(21) Appl. No.: 13/683,399

(22) Filed: Nov. 21, 2012

(51) Int. Cl. G06F 17/30

(52) U.S. Cl. CPC G06F 17/30386
USPC 707/781

(57) ABSTRACT

The disclosure generally describes computer-implemented methods, software, and systems for creating consumer-specific controller objects from business objects. One computer-implemented method includes identifying a business object, creating a first controller associated with the identified business object, wherein the first controller includes a set of attributes associated with the identified business object, identifying a first set of accessible attributes from the set of attributes to which the first controller should allow access, and configuring the first controller to allow access to the first set of accessible attributes.

### TECHNICAL FIELD

The present disclosure relates to computer-implemented methods, software, and systems for creating consumer-specific controller objects from business objects.

### BACKGROUND

The model-view-controller (MVC) design pattern is an architecture that separates the representation of information from the interactions of various consumers with the information. Generally, a model includes information such as business logic and data. A controller serves as a mediator between the consumer and the model, generally accepting input from a consumer (such as requests) and translating or converting the requests into a format usable by the model. A view may be any output representation of the data in the model. MVC architectures generally promote code reusability, as the underlying data model does not change when the information must be presented or requested in a new way. MVC architectures also promote the design principle of separation of concerns, in which each module of a computing system implements specific features and there is very little feature overlap between different modules.

### SUMMARY

The present disclosure relates to computer-implemented methods, software, and systems for creating consumer-specific controller objects from business objects. One computer-implemented method includes identifying a business object, creating a first controller associated with the identified business object, wherein the first controller includes a set of attributes associated with the identified business object, identifying a first set of accessible attributes from the set of attributes to which the first controller should allow access, and configuring the first controller to allow access to the first set of accessible attributes.

The foregoing and other implementations can each optionally include one or more of the following features, alone or in combination. In particular, one implementation can include all the following features:

In a first aspect, combinable with the general implementation, the first controller is further configured to provide access to at least a portion of the first set of accessible attributes to a first consumer associated with the first controller, and translate at least a portion of the first set of accessible attributes into a format associated with the first consumer.

In a second aspect, combinable with the general implementation, the first controller is further configured to provide access to additional data not included in the first set of accessible attributes to the first consumer.

In a third aspect, combinable with the general implementation, the first controller includes a set of instructions specific to the first consumer.

In a fourth aspect, combinable with the general implementation, the method further comprises creating a second controller different from the first controller and associated with the identified business object, wherein the second controller includes the set of attributes associated with the identified business object and the second controller is associated with a second consumer different than the first consumer, identifying a second set of accessible attributes from the set of attributes to which the second controller should allow access, and configuring the second controller to allow access to the first set of accessible attributes.

In a fifth aspect, combinable with the general implementation, the method further comprising creating a third controller different from the first controller and the second controller and associated with the identified business object, wherein the third controller inherits from the second controller.

In a sixth aspect, combinable with the general implementation, the method further comprises creating a first lock class associated with the first controller operable to lock the identified business object when the first controller is accessed.

In a seventh aspect, combinable with the general implementation, the first controller inherits the set of attributes associated with the identified business object from the identified business object.

In an eighth aspect, combinable with the general implementation, the method further comprises identifying a set of restricted attributes from the set of attributes to which the first controller should restrict access, and configuring the first controller to restrict access to the set of restricted attributes

The subject matter described in this specification can be implemented in particular implementations so as to realize one or more of the following advantages. First, greater organization and maintainability may be realized by using a common methodology for both business objects and controller objects. Second, consumer-specific functionality may be more easily implemented without modifying the underlying business object and thus violating the design principle of separation of concerns. Third, controller objects may improve runtime performance, as all the information to expose to the consumer is included in the controller object. Accordingly, the business object may not need to be accessed. Fourth, controller objects also provide a spot for integration of consumer-specific behavior, actions and data without the need to modify the underlying business object. Consumer-specific behaviors such as authorization checks, custom message handling, and properties for different attributes may be implemented using controller objects. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for allowing the creation of consumer-specific controller objects from business objects.

FIG. 2 is a block diagram illustrating an architecture including consumer-specific controller objects created according to various aspects of the present disclosure.

FIG. 3 is a block diagram illustrating the relationships between an example business object, an example controller object, and an example consumer.

FIG. 4 is a flow chart illustrating an example method for creating a consumer-specific controller object based on a business object.

FIG. 5 is a flow chart illustrating an example method for creating multiple independent controller objects associated with different consumers and based on the same business object.

Like reference numbers and designations in the various drawings indicate like elements.

### DETAILED DESCRIPTION

This disclosure generally describes computer-implemented methods, software, and systems for allowing the creation of consumer-specific controller objects from business objects.

Many modern applications follow the MVC design pattern discussed above. This approach helps to separate business logic and data from its consumers. Consumers of business logic and data may include user interfaces, web services and other systems. In order to keep the business logic free from consumer-specific functionality, controllers are used. Controllers are consumer-specific objects that provide access to business logic and data the particular consumer is interested in and/or allowed to access. The controller may also convert the data into a consumer friendly format.

From a development perspective it is important that every consumer has a dedicated controller in order to expose only those parts and features of a business object that are relevant in the use case context. For example, for a consumer of reporting data it is not necessary for the controller to expose an “edit” or “create” function of a business object, as the consumer is only interested in receiving reporting information and not modifying the business object. Dedicated controllers also promote the design principle of “separation of concerns” and hence limit undesirable side effects.

One goal of the present disclosure is to provide dedicated controller objects that inherit from and expose attributes of business objects in a uniform manner. In some cases, the controller objects are themselves business objects, and are managed by the same systems as the business objects from which they inherit. Accordingly, design tools and methodologies that have been developed for authoring business objects can also be used to author and maintain controller objects, which may lead to increased efficiency and ease of use.

Controller objects generally expose attributes of the underlying business object to a consumer. However, in some cases the controller object may include additional functionality to perform additional processing, calculations, formatting or other operations on the attributes inherited from the business object, and may also add or derive additional attributes not included in the original business object. In other cases, the controller object may restrict access of the consumer to certain business object attributes.

Using controller objects may increase transparency (and therefore maintainability and total cost of development) enormously for several reasons. First, at design time, several distinct objects exist (one for the business object and one for each associated controller). Each object can be maintained and documented separately, leading to superior organization. Second, a single framework may be used for authoring and maintaining all objects, as the controller objects and business objects are implemented according to the same principles.

Controller objects may also improve runtime performance, as all the information to expose to the consumer is included in the controller object. Accordingly, the business object may not need to be accessed. Controller objects also provide a spot for integration of consumer-specific behavior, actions and data without the need to modify the underlying business object. Consumer-specific behaviors such as authorization checks, custom message handling, and properties for different attributes may be implemented using controller objects.

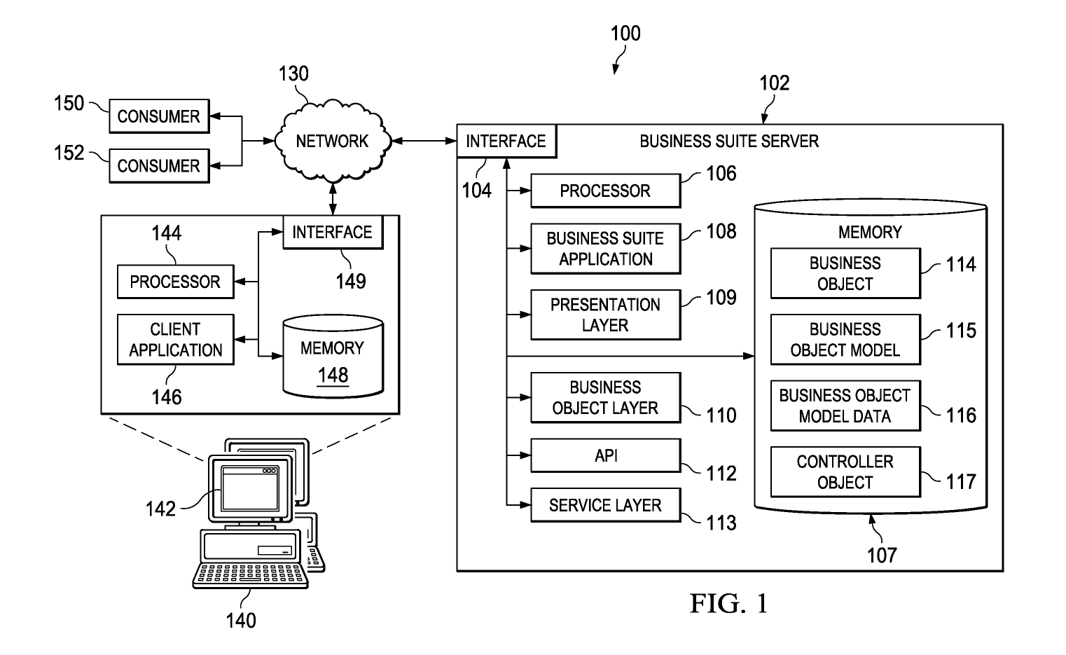

FIG. 1 illustrates an example distributed computing system 100 operable to allow the creation of consumer-specific controller objects from business objects. Specifically, the illustrated example distributed computing system 100 includes or is communicably coupled with a business suite server 102, a client 140, and a plurality of consumers 150, 152 that communicate across a network 130.

In general, the business suite server 102 is a server that stores one or more business applications 108, where at least a portion of the business applications 108 are executed via requests and responses sent to users or clients within and communicably coupled to the illustrated example distributed computing system 100. In some implementations, the business suite server 102 may store a plurality of various business applications 108. In other implementations, the business suite server 102 may be a dedicated server meant to store and execute only a single business application 108. In some implementations, the business suite server 102 may comprise a web server, where the business applications 108 represent one or more web-based applications accessed and executed by the client 140 via the network 130 or directly at the business suite server 102 to perform the programmed tasks or operations of the business application 108.

At a high level, the business suite server 102 comprises an electronic computing device operable to receive, transmit, process, store, or manage data and information associated with the example distributed computing system 100. Specifically, the business suite server 102 illustrated in FIG. 1 is responsible for receiving application requests, for example business suite navigation requests, from one or more client applications associated with the client 140 of the example distributed computing system 100 and responding to the received requests by processing said requests in the associated business application 108, and sending the appropriate response from the business application 108 back to the requesting client application 146. In addition to requests from the client 140, requests associated with the business applications 108 may also be sent from internal users, external or third-party customers, other automated applications, as well as any other appropriate entities, individuals, systems, or computers.

In some implementations, client application 146 is an application that allows for the specification and design of business objects. In such implementations, the client application 146 may be a graphical application that allows a user to specify different attributes and functionality associated with a business object. The client application 146 may also be used to create controller objects associated with the business object. In some cases, the client application 146 may be used to identify attributes of the business object that are to be exposed to consumers via the controller object. The client application 146 may also be operable to allow a developer to author functionality specific to the created controller, such as by entering programming instructions or dragging and dropping pre-authored code sections. In some implementations, the client application 146 is a visual application that allows a designer to manipulate representations of various objects to create the desired functionality. In other implementations, the client application 146 allows a designer to enter instructions to define the functionality of various objects. In still other implementations, the client application 146 includes a combination of visual and text-based, instruction entry functionality.

As used in the present disclosure, the term “computer” is intended to encompass any suitable processing device. For example, although FIG. 1 illustrates a single business suite server 102, environment 100 can be implemented using two or more servers 102, as well as computers other than servers, including a server pool. Indeed, business suite server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated business suite server 102 may be adapted to execute any operating system, including LINUX, UNIX, WINDOWS, MAC OS, JAVA, ANDROID, IOS or any other suitable operating system. According to one implementation, business suite server 102 may also include or be communicably coupled with an e-mail server, a web server, a caching server, a streaming data server, and/or other suitable server.

The business suite server 102 also includes an interface 104, a processor 106, and a memory 107. The interface 104 is used by the business suite server 102 for communicating with other systems in a distributed environment—including within the environment 100—connected to the network 130; for example, the client 140, as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

As illustrated in FIG. 1, the business suite server 102 includes a processor 106. Although illustrated as a single processor 106 in FIG. 1, two or more processors may be used according to particular needs, desires, or particular implementations of the environment 100. Each processor 106 may be a central processing unit (CPU), a blade, an application specific integrated circuit (ASIC), a field-programmable gate array (FPGA), or another suitable component. Generally, the processor 106 executes instructions and manipulates data to perform the operations of the business suite server 102. Specifically, the processor 106 executes the functionality required to receive and respond to requests from the client 140 and/or allowing creation of consumer-specific controller objects from business objects.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Objective C, JAVA, VISUAL BASIC, assembler, PERL, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The business suite server 102 also includes a memory 107, or multiple memories 107. The memory 107 may include any type of memory or database module and may take the form of volatile and/or non-volatile memory including, without limitation, magnetic media, optical media, random access memory (RAM), read-only memory (ROM), removable media, or any other suitable local or remote memory component. The memory 107 may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto associated with the purposes of the business suite server 102. Additionally, the memory 107 may include any other appropriate data, such as VPN applications, firmware logs and policies, firewall policies, a security or access log, print or other reporting files, as well as others. While memory 107 is illustrated as in integral component of the business suite server 102, in alternative implementations memory 107 can be external to the business suite server 102 and/or the example distributed computing system 100.

In some implementations, any and/or all of components of the business suite server 102, both hardware and/or software, may interface with each other and/or the interface using an application programming interface (API) 112 and/or a service layer 113. The API 112 may include specifications for routines, data structures, and object classes. The API 112 may be either computer language independent or dependent and refer to a complete interface, a single function, or even a set of APIs. The service layer 113 provides software services to the example distributed computing system 100. The functionality of the business suite server 102 may be accessible for all service consumers using this service layer. Software services, such as provide reusable, defined business functionalities through a defined interface. For example, the interface may be software written in JAVA, C++, or other suitable language providing data in extensible markup language (XML) format or other suitable format. While illustrated as integrated components of the business suite server 102 in the example distributed computing system 100, alternative implementations may illustrate the API 112 and/or service layer 113 as stand-alone components in relation to other components of the example distributed computing system 100. Moreover, any or all parts of the API 112 and/or service layer 113 may be implemented as child or sub-modules of another software module, enterprise application, or hardware module without departing from the scope of this disclosure.

The memory 107, i.e., a back-end data system, holds data for the business suite server 102. In some implementations, the memory 107 includes a business object 114, business object model 115, and business object model data 116. Although illustrated as single instances, there may be more than one instance of the business object 114, business object model 115, and business object model data 116.

The business object 114 can be considered a representation of an intelligible business/non-business entity, such as an account, an order, an employee, an invoice, a financial report, etc. The business object 114 may encompass both functions, for example, in the form of methods, and data, such as one or more properties. For example, an account business object 114 may have properties such as Name, Priority, Value, etc. Business objects 114 may reduce system complexity by reducing a system into smaller units. The implementation details of business objects 114 are typically hidden from a non-development user and may be accessed through the defined functions and encapsulated data. Business objects 114 also form a point of entry of the functions and data of a system and enable the system to easily share, communicate, display, or otherwise operate with other systems. A business object 114 may also be considered the target of a request for data in a particular business suite, for example through a web page, and may contain a view to be displayed when the business object 114 is accessed. In some implementations, the business object 114 can control the location of a selected view, personalized views for a specific business suite user, and dynamic views. While illustrated as integrated with memory 107 of the business suite server 102 in the example distributed computing system 100, in alternative implementations the business object 114 can be stored external to the business suite server 102.

The business object model 115 is a structured way of representing relationships, associations, roles, etc. of business objects 114 applicable to an organization. For example, the business object model 115 may be represented through the use of an entity-relationship diagram (ERD) or other suitable diagram or descriptive method. An example a business object model 115 for ProductSeller may include root business objects 114 such as Account and Order, each of which may contain their own methods, properties, and relationships to other dependent objects in the business object model 115. The root business objects 114 may also have associations with other dependent business objects 114. Examples of a dependent object for the Account root business object 114 may include AccountAddressUS. Example dependent objects for the Order root business object 114 may include OrderPartner and OrderItemShipmentData. While illustrated as integrated with memory 107 of the business suite server 102 in the example distributed computing system 100, in alternative implementations the business object model 115 can be stored external to the business suite server 102.

The business object model data 116 is data associated with a specific instance of a business object 114. For example, for the example AccountAddressUS dependent object above, there may be properties Name, Title, Address1, Address2, City, State, and PostalCode. Business object model data 116 would be the data associated with each property, for example, Name=“XYZ, Inc.”, Address1=“12345 Any Street”, Address2=“Suite ABC”, City=“Some City”, etc. In some implementations, the business object model data 116 may include, among other things: text, images, sounds, videos, and animations. While illustrated as integrated with memory 107 of the business suite server 102 in the example distributed computing system 100, in alternative implementations the business object model data 116 can be stored external to the business suite server 102.

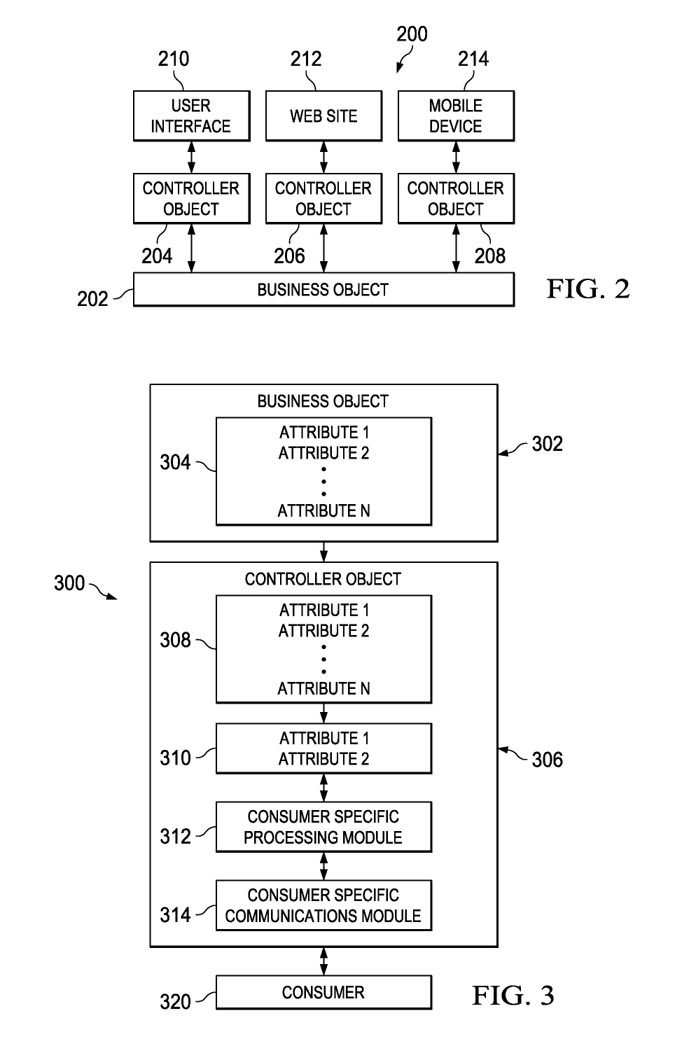

The controller object 117 is associated with a specific instance of a business object 114. Generally, the controller object 117 exposes attributes of the business object 114 to a specific consumer from the set of consumers 150 and 152. In some implementations, the controller object 117 may expose the attributes of the business object 114 by receiving requests for the attributes, translating the attributes into a format or protocol associated with the consumer, and sending a response including the attributes to the consumer. In other implementations, the controller object 117 may expose functionality associated with the business object 114 by allowing the consumer to call methods associated with the business object 114. In such a case, the controller object 117 would receive a request from the consumer, and call the method associated with the request on the consumer's behalf, sending the output of the method to the consumer. In some cases, the controller object 117 is associated with the business object 114 by an inheritance relationship, as discussed in more detail relative to FIG. 2.

The illustrated example distributed computing system 100 also includes the client 140, or multiple clients 140. The client 140 may be any computing device operable to connect to or communicate with at least the business suite server 102 via the network 130 using a wireline or wireless connection. In general, the client 140 comprises an electronic computer device operable to receive, transmit, process, and store any appropriate data associated with the example distributed computing system 100.

The illustrated client 140 further includes a client application 146. The client application 146 is any type of application that allows the client 140 to request and view content on the client 140. In some implementations, the client application 146 can be and/or include a web browser. In some implementations, the client-application 146 can use parameters, metadata, and other information received at launch to access a particular set of data from the server 102. Once a particular client application 146 is launched, a user may interactively process a task, event, or other information associated with the business suite server 102. Further, although illustrated as a single client application 146, the client application 146 may be implemented as multiple client applications in the client 140.

The illustrated client 140 further includes an interface 149, a processor 144, and a memory 148. The interface 149 is used by the client 140 for communicating with other systems in a distributed environment—including within the example distributed computing system 100—connected to the network 130; for example, the business suite server 102, as well as other systems communicably coupled to the network 130 (not illustrated). Generally, the interface 149 comprises logic encoded in software and/or hardware in a suitable combination and operable to communicate with the network 130. More specifically, the interface 149 may comprise software supporting one or more communication protocols associated with communications such that the network 130 or interface's hardware is operable to communicate physical signals within and outside of the example distributed computing system 100.

As illustrated in FIG. 1, the client 140 includes a processor 144. Although illustrated as a single processor 144 in FIG. 1, two or more processors may be used according to particular needs, desires, or particular implementations of the example distributed computing system 100. Each processor 144 may be a central processing unit (CPU), an application specific integrated circuit (ASIC), a field-programmable gate array (FPGA), or another suitable component. Generally, the processor 144 executes instructions and manipulates data to perform the operations of the client 140. Specifically, the processor 144 executes the functionality required to send requests to the business suite server 102 and to receive and process responses from the business suite server 102.

Further, the illustrated client 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the business suite server 102.

The illustrated client 140 also includes a memory 148, or multiple memories 148. The memory 148 may include any memory or database module and may take the form of volatile or non-volatile memory including, without limitation, magnetic media, optical media, random access memory (RAM), read-only memory (ROM), removable media, or any other suitable local or remote memory component. The memory 148 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client 140. Additionally, the memory 148 may include any other appropriate data, such as VPN applications, firmware logs and policies, firewall policies, a security or access log, print or other reporting files, as well as others.

There may be any number of clients 140 associated with, or external to, the example distributed computing system 100. For example, while the illustrated example distributed computing system 100 includes one client 140, alternative implementations of the example distributed computing system 100 may include multiple clients 140 communicably coupled to the business suite server 102 and/or the network 130, or any other number suitable to the purposes of the example distributed computing system 100. Additionally, there may also be one or more additional clients 140 external to the illustrated portion of the example distributed computing system 100 that are capable of interacting with the example distributed computing system 100 via the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the business suite server 102 or the client 140 itself, including digital data, visual information, or a GUI 142, as shown with respect to the client 140.

The consumers 150 and 152 interact with the business suite server 102 to request and retrieve information related to the business objects contained therein. In some cases, the consumers 150 and 152 interact with controller objects in order to request and retrieve the information. In some cases, each consumer is associated with a single controller object, while in other implementations, multiple consumers may be associated with the same controller object. In the illustrated implementation, the consumers 150 and 152 request and retrieve information from the business suite system via network 130. In other implementations, the consumers 150 and 152 may be components integrated into or associated with the business suite server 102. In other implementations, the consumers 150 and 152 may request information via the network 130, and the information may be presented to them at a later time or via a different mechanism (such as through email).

Turning now to FIG. 2, a block diagram is shown illustrating an example system 200 including consumer-specific controller objects created according to various aspects of the present disclosure.

Example system 200 includes a business object 202. In some cases, business object 202 is similar to or identical to the business object 114 depicted in FIG. 1. In other cases, business object 202 is implemented according to any other appropriate technique or combination of techniques.

The illustrated system 200 also includes a plurality of controller objects 204, 206, and 208. In the illustrated system 200, each of the controller objects 204, 206, and 208 are associated with business object 202. In some instances, the controller objects 204, 206 and 208 are associated with the business object 202 by an inheritance relationship. That is, they are based on the business object 202 such that they include a portion of the data and functionality included in the business object 202. In some cases, the controller objects 204, 206 and 208 may extend the business object 202 by adding additional attributes, logic or other functionality to the business object 202. For example, the controller objects 204, 206 and 208 may add functions to convert, translate or otherwise manipulate the data inherited from the business object 202 into a format suitable for an associated consumer. In some cases, the controller objects 204, 206 and 208 may perform the “controller” role from the “model-view-controller” design pattern discussed previously, while in other cases, the controller objects 204, 206, and 208 may perform both the “controller” and the “view” roles by both receiving commands from and providing business object data to the associated consumers.

As illustrated, example system 200 includes a plurality of consumers: a user interface 210, web site 212, and mobile device 214. In the illustrated implementations, the user interface 210 is associated with controller object 204, the web site 212 is associated with controller object 206, and the mobile device 214 is associated with controller object 208. In other implementations, the user interface 210, the web site 212, and the mobile device 214 may all be associated with the same controller object. This configuration may occur where the three consumers all request and receive data in a common format or protocol, such as, for example, hypertext markup language (HTML).

In the illustrated implementation, the user interface 210 is associated with controller 204. The controller 204 may receive requests for and provide information from business object 202 in a format generally associated with user interfaces. For example, the controller 204 may implement an X Window version 11 (X11) compliant interface to the user interface 210 to present the information in the business object 202. In other implementations, the user interface 210 receives data from the controller object in a standard format and presents the information to a user.

The illustrated web site 212 is associated with controller object 206. In some cases, the web site 212 may receive data from the controller object 206 in a raw format and convert the data into a format accessible via a web browser, such as, for example, HTML. In other implementations, the data may be received from the controller object 206 in such a browser-friendly format so that no data conversion is required.

In the illustrated case, mobile device 214 is associated with controller object 208. In some cases, the mobile device 214 receives the data associated with the business object 202 from the controller object 208 in a format that is easily viewable on a mobile device such as a smartphone or tablet. In other implementations, the controller object 208 provides the data in a raw format and the mobile device 214 converts the data appropriately.

In other implementations, the controller objects 204, 206, 208 may be associated with one another such that one controller object inherits from another. For example, controller object 206 is associated with web site 212, and thus may produce a data stream formatted in HTML. Controller object 208 is associated with mobile device 214, and thus may also want to produce an HTML data stream, but may wish to format it for the smaller screen of mobile device 214. In such a case, the controller object 208 may be created as a child of controller object 206, such that it inherits all the functionality of controller object 206. The controller object 208 may then be modified to add the functionality necessary to format to HTML stream for mobile device 214.

Referring now to FIG. 3, a block diagram illustrating an example system 300 is shown. The example system 300 depicts the relationships between an example business object, an example controller object, and an example consumer.

Example system 300 includes a business object 302. In some implementations, business object 302 is identical or similar to business object 202 shown in FIG. 2, while in other implementations business object 302 is implemented according to any other technique or combination of techniques.

The illustrated business object 302 includes a set of attributes 304. In some cases, these attributes may be variables included in the business object, while in other cases the attributes may be member functions, procedures, methods, properties or any other appropriate attribute of a business object. In some cases, the attributes may include references to other business objects, attributes, methods, or other entities within the system, such as pointers, addresses, or any other form of reference.

As illustrated, business object 302 is associated with controller object 306. In some cases, the controller object 306 inherits from and extends the business object 302. In other cases, the controller object 306 is related to the business object 302 in another appropriate manner, such as, for example, by implementing an interface associated with the business object 302, extending an abstract class associated with the business object 302, or any other manner or combination of manners.

The controller object 306 includes a set of inherited attributes 308. In some cases, these attributes are identical to the attributes 304 of business object 302. In other implementations, the inherited attributes 308 may include only certain of the attributes 304. For example, in some cases, certain ones of the attributes 304 may be designated as “private” and thus not inherited by the controller object 306. In some cases, the controller object 306 includes a reference to the attributes 304, while in other cases, the controller object 306 includes a copy of the attributes 304.

Controller object 306 also includes a set of accessible attributes 310. In some cases, the controller object 306 exposes all attributes of the business object 302, and thus the controller object 306 does not include a set of accessible attributes 310. In other cases, the set of accessible attributes 310 represents the set of attributes to which the consumer 320 may have access. In some cases, the set of accessible attributes 310 is defined by a designer, such as by using client application 146 discussed in FIG. 1. In other cases, the set of accessible attributes is defined by the consumer 320 by sending a set of attributes to which it desires access. In some cases, the accessible attributes 310 are implemented as a list of the attributes 308 that should be exposed, while in other cases, a distinct copy of the attributes 308 is made. In other cases, accessible attributes 310 include only references to the attributes 308.

As illustrated, controller object 306 also includes a consumer-specific processing module 312. In some cases, consumer-specific processing module 312 includes functionality to format the values in the set of accessible attributes 310 such that they are readable or usable by consumer 320. For example, the consumer-specific processing module 312 may format the accessible attributes 310 inside a table on an HTML page for a consumer that wishes to present a report that is accessible via a web browser. In other cases, the consumer-specific processing module 312 may perform calculations involving the accessible attributes 310 in order to present a digest or summary of the attributes 310. In still other implementations, the consumer-specific processing module 312 may receive requests from the consumer 320 and return appropriate attributes from the accessible attributes 310 as appropriate. In other cases, the consumer-specific processing module 312 may include methods that may be called by the consumer 320 to perform calculations using the accessible attributes 310. In other cases, the consumer-specific processing module 312 may include accessor functions used by the consumer to access the accessible attributes 310, rather than accessing them directly.

Controller object 306 also includes a consumer-specific communications module 314. In some cases, the consumer-specific communications module 314 receives messages from the consumer 320 and converts or translates the messages into a format the consumer-specific processing module 312 can utilize. In other cases, the consumer-specific communications module 314 is responsible for formatting the data sent to consumer 320 into a format or protocol appropriate for the consumer 320.

As illustrated, consumer 320 is communicably or otherwise coupled to controller object 306. In some implementations, the consumer 320 is similar to or identical to consumers 150 and 152 discussed relative to FIG. 1, while in other implementations the consumer 320 is implemented according to any other technique or combination of techniques.

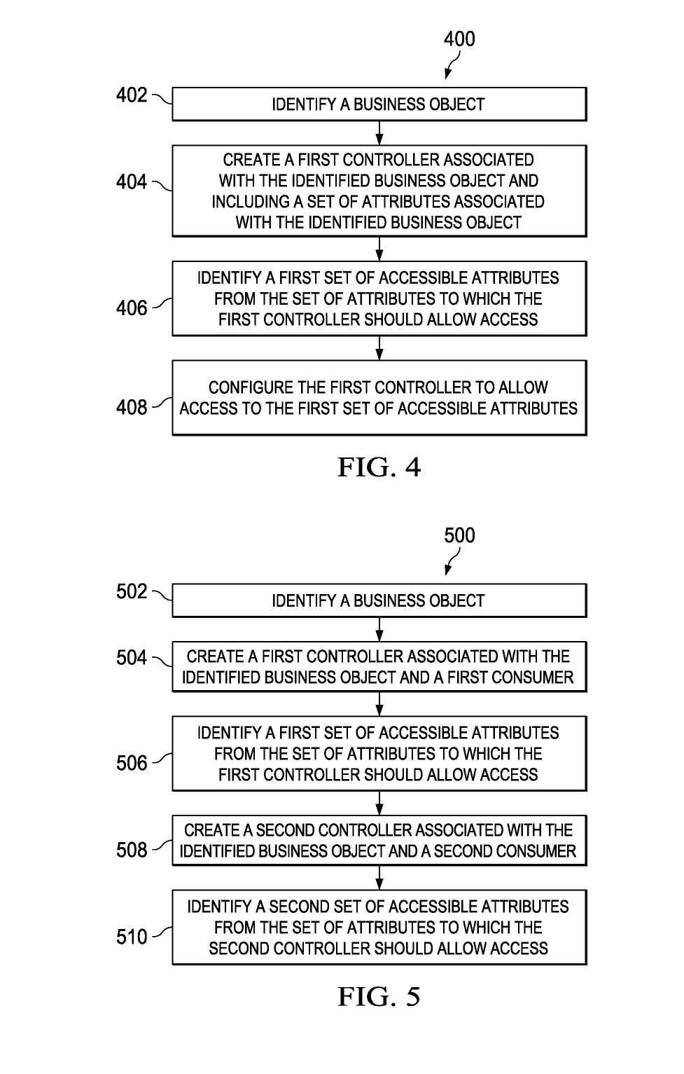

FIG. 4 is a flow chart illustrating an example method 400 for creating a consumer-specific controller object based on a business object. For clarity of presentation, the description that follows generally describes method 400 in the context of FIGS. 1-3. However, it will be understood that method 400 may be performed, for example, by any other suitable system, environment, software, and hardware, or a combination of systems, environments, software, and hardware as appropriate.

At 402, a business object is identified. In some cases, the business object is identified by a designer or user indicating a particular a business on a graphical user interface, such as by clicking another business object using a mouse. In other cases, the designer identifies the business object by entering instructions into a text or other editor including a reference to the business object. In other cases, the business object is identified by some automated process such as a software application.

At 404, a first controller is created associated with the identified business object and including a set of attributes associated with the identified business object. In some cases, the controller is created in response to the designer executing a command to create the first controller. In other cases, the controller is created automatically in response to the designer or other actor identifying the business object.

At 406, a first set of accessible attributes from the set of attributes to which the first controller should allow access is identified. In some cases, the first set of accessible attributes is identified by the designer selecting attributes from the set of attributes associated with the business object. In other cases, the attributes are identified according to properties of the attributes themselves. For example, the identified business object may include properties associated with each attribute such as “public” or “private.” In such a case, public attributes would be identified as accessible, while private attributes would not. In still other cases, the set of accessible attributes is determined by an external system, such as, for example, a permissions system specifying to which attributes an associated consumer should have access.

At 408, the first controller is configured to allow access to the first set of accessible attributes. In some cases, configuring the first controller includes setting properties of the first controller such that it will allow access. In other cases, configuring the first controller includes generating code to include in the first controller to allow access to the accessible attributes. In other cases, configuring the first controller includes prompting the designer to specify techniques or mechanisms for providing access to the accessible attributes.

FIG. 5 is a flow chart illustrating an example method 500 for creating multiple independent controller objects associated with different consumers and based on the same business object. For clarity of presentation, the description that follows generally describes method 500 in the context of FIGS. 1-3. However, it will be understood that method 500 may be performed, for example, by any other suitable system, environment, software, and hardware, or a combination of systems, environments, software, and hardware as appropriate.

At 502, a business object is identified. In some cases, the identification of the business object is similar to or identical to 402 from FIG. 4, while in other implementations the identification is performed according to any other appropriate technique or combination of techniques.

At 504, a first controller is created associated with the identified business object and a first consumer. In some cases, the controller is created in response to the designer executing a command to create the first controller. In other cases, the controller is created automatically in response to the designer or other actor identifying the business object. In some cases, the first controller is explicitly associated with the first consumer, while in other cases, the first controller is implemented such that it responds to and sends messages according to formats and protocols acceptable for the first consumer.

At 506, a first set of accessible attributes is identified from the set of attributes to which the first controller should allow access. In some cases, the identification of the accessible attributes is similar to or identical to 406 from FIG. 4, while in other implementations, the identification is performed according to any other appropriate technique or combination of techniques.

At 508, a second controller is created associated with the identified business object and a second consumer. In some cases, the controller is created in response to the designer executing a command to create the second controller. In other cases, the controller is created automatically in response to the designer or other actor identifying the business object. In some cases, the second controller is explicitly associated with the second consumer, while in other cases, the first controller is implemented such that it responds to and sends messages according to formats and protocols acceptable for the second consumer. In some cases, the second controller responds to and sends data in a protocol different from the first controller, while in other cases, the protocol is identical.

At 510, a second set of accessible attributes is identified from the set of attributes to which the second controller should allow access. In some cases, the identification of the accessible attributes is similar to or identical to 406 from FIG. 4, while in other implementations the identification is performed according to any other appropriate technique or combination of techniques. In some cases, the set of accessible attributes for the first controller is different from the set of accessible attributes for the second controller.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program include, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method executed by one or more processors, the method comprising:
identifying a business object;
creating a first controller associated with the identified business object, wherein the first controller includes a set of attributes associated with the identified business object;
identifying a first set of accessible attributes from the set of attributes to which the first controller should allow access; and
configuring the first controller to allow access to the first set of accessible attributes.

2. The computer-implemented method of claim 1, wherein the first controller is further configured to:
provide access to at least a portion of the first set of accessible attributes to a first consumer associated with the first controller; and
translate at least a portion of the first set of accessible attributes into a format associated with the first consumer.

3. The computer-implemented method of claim 2, wherein the first controller is further configured to provide access to additional data not included in the first set of accessible attributes to the first consumer.

4. The computer-implemented method of claim 2, wherein the first controller includes a set of instructions specific to the first consumer.

5. The computer-implemented method of claim 2, further comprising:
creating a second controller different from the first controller and associated with the identified business object, wherein the second controller includes the set of attributes associated with the identified business object and the second controller is associated with a second consumer different than the first consumer;
identifying a second set of accessible attributes from the set of attributes to which the second controller should allow access; and
configuring the second controller to allow access to the first set of accessible attributes.

6. The computer-implemented method of claim 5, further comprising:
creating a third controller different from the first controller and the second controller and associated with the identified business object, wherein the third controller inherits from the second controller.

7. The computer-implemented method of claim 1, further comprising:
creating a first lock class associated with the first controller operable to lock the identified business object when the first controller is accessed.

8. The computer-implemented method of claim 1, wherein the first controller inherits the set of attributes associated with the identified business object from the identified business object.

9. The computer-implemented method of claim 1, further comprising:
identifying a set of restricted attributes from the set of attributes to which the first controller should restrict access; and
configuring the first controller to restrict access to the set of restricted attributes.

10. A non-transitory, computer-readable medium storing computer-readable instructions executable by a computer to:
identify a business object;
create a first controller associated with the identified business object, wherein the first controller includes a set of attributes associated with the identified business object;
identify a first set of accessible attributes from the set of attributes to which the first controller should allow access; and
configure the first controller to allow access to the first set of accessible attributes.

11. The computer-readable medium of claim 10, wherein the first controller is further configured to:
provide access to at least a portion of the first set of accessible attributes to a first consumer associated with the first controller; and
translate at least a portion of the first set of accessible attributes into a format associated with the first consumer.

12. The computer-readable medium of claim 11, wherein the first controller is further configured to provide access to additional data not included in the first set of accessible attributes to the first consumer.

13. The computer-readable medium of claim 11, wherein the first controller includes a set of instructions specific to the first consumer.

14. The computer-readable medium of claim 11, storing computer-readable instructions executable by a computer to:
create a second controller different from the first controller and associated with the identified business object, wherein the second controller includes the set of attributes associated with the identified business object and the second controller is associated with a second consumer different than the first consumer;
identify a second set of accessible attributes from the set of attributes to which the second controller should allow access; and
configure the second controller to allow access to the first set of accessible attributes.

15. The computer-readable medium of claim 14, storing computer-readable instructions executable by a computer to:
create a third controller different from the first controller and the second controller and associated with the identified business object, wherein the third controller inherits from the second controller.

16. The computer-readable medium of claim 10, storing computer-readable instructions executable by a computer to:
create a first lock class associated with the first controller operable to lock the identified business object when the first controller is accessed.

17. The computer-readable medium of claim 10, wherein the first controller inherits the set of attributes associated with the identified business object from the identified business object.

18. The computer-readable medium of claim 10, storing computer-readable instructions executable by a computer to:
identify a set of restricted attributes from the set of attributes to which the first controller should restrict access; and
configure the first controller to restrict access to the set of restricted attributes.

19. A system, comprising:
memory for storing data; and
one or more processors operable to:
identify a business object;
create a first controller associated with the identified business object, wherein the first controller includes a set of attributes associated with the identified business object;
identify a first set of accessible attributes from the set of attributes to which the first controller should allow access; and
configure the first controller to allow access to the first set of accessible attributes.

20. The system of claim 19, the one or more processors further operable to:
provide access to at least a portion of the first set of accessible attributes to a first consumer associated with the first controller; and
translate at least a portion of the first set of accessible attributes into a format associated with the first consumer.

21. A computer-implemented method executed by one or more processors, the method comprising:
identifying a business object;
creating a first controller associated with the identified business object, wherein the first controller includes a set of attributes associated with the identified business object;
identifying a first set of accessible attributes from the set of attributes to which the first controller should allow access;
configuring the first controller to allow access to the first set of accessible attributes;
creating a second controller different from the first controller and associated with the identified business object, wherein the second controller includes the set of attributes associated with the identified business object and the second controller is associated with a second consumer different than the first consumer;
identifying a second set of accessible attributes from the set of attributes to which the second controller should allow access; and
configuring the second controller to allow access to the first set of accessible attributes,
wherein the first controller and the second controller inherit the set of attributes associated with the identified business object from the identified business object,
wherein the first controller is configured to provide access to at least a portion of the first set of accessible attributes to a first consumer associated with the first controller, and translate at least a portion of the first set of accessible attributes into a format associated with the first consumer, and
wherein the second controller is configured to provide access to at least a portion of the second set of accessible attributes to a second consumer associated with second first controller, and translate at least a portion of the second set of accessible attributes into a format associated with the second consumer,
